(19) United States
(12) Patent Application Publication
(10) Pub. No.: US 2017/0328803 A1
(43) Pub. Date: Nov. 16, 2017

(54) POSITION ESTIMATION DEVICE, POSITION ESTIMATION SYSTEM, POSITION ESTIMATION METHOD, AND COMPUTER-READABLE RECORDING MEDIUM

(71) Applicant: NEC Corporation, Tokyo (JP)

(72) Inventors: Takahiro KUMURA, Tokyo (JP); Soichiro TAKATA, Tokyo (JP); Yasuhiro SASAKI, Tokyo (JP)

(73) Assignee: NEC Corporation, Tokyo (JP)

(21) Appl. No.: 15/529,003

(22) PCT Filed: Nov. 24, 2015
(86) PCT No.: PCT/JP2015/005840

§ 371 Date: May 23, 2017

(30) Foreign Application Priority Data
Nov. 25, 2014 (JP) 2014-238050

(51) Int. Cl. G01L 23/00

(52) U.S. Cl. CPC G01L 23/00

(57) ABSTRACT

Provided is a position estimation device and the like which accurately estimate an occurrence position of a pressure wave. The position estimation device is provided with: a first cross-correlation derivation means for deriving a first cross-correlation relating to a pressure of fluid based on measurement values obtained by measuring a pressure of fluid flowing through a pipeline network at least at two positions in the pipeline network, a second cross-correlation derivation means for deriving a second cross-correlation relating to a pressure of fluid based on calculation values obtained by calculating a pressure of fluid at least at the two positions in the pipeline network, and an estimation means for estimating an occurrence position of a pressure wave based on a difference between the first cross-correlation and the second cross-correlation.

### TECHNICAL FIELD

The present invention relates to a position estimation device, a position estimation system, a position estimation method, and a computer-readable recording medium.

### BACKGROUND ART

In a pipeline network through which fluid such as liquid or gas flows, due to a change in the flow rate of fluid flowing through the pipeline network, a large pressure wave (hereinafter referred to as an “excessive pressure wave”) as compared with a case where fluid constantly flows may be generated. A cause of generation of an excessive pressure wave may be a sudden operation of a pump, a valve or the like, a sudden change in the use amount of water, a fault or rupture of a pipe constituting a pipeline network, and the like, for instance.

An excessive pressure wave exerts a load in a pipeline network. Therefore, an excessive pressure wave may deteriorate a pipeline network, or may be a factor of a fault or rupture of a pipe constituting a pipeline network. In view of the above, it is possible to extend the life span of a pipeline network by obtaining a position where an excessive pressure wave is generated, and by eliminating a factor of generation of an excessive pressure wave at the position.

One of the methods for specifying a position where an excessive pressure wave is generated is to deploy many pressure meters along a pipe constituting a pipeline network, and to check a pressure of fluid flowing through the pipeline network in detail. However, deploying many pressure meters in a pipeline network generally costs high. Therefore, a method for estimating a position where an excessive pressure wave is generated with a minimum number of pressure meters is developed.

NPL 1 describes a technique in which a burst position is estimated by using wave characteristics of a single pipe. NPL 2 describes a technique in which a burst position is estimated by analyzing a flow rate or the like in a pipeline network immediately after burst is generated. NPL 3 describes a technique in which a pipeline network is divided into several areas, and a fluid leakage area is estimated by using a discrepancy between inflow and outflow of fluid with respect to the areas as an index. NPL 4 describes a technique in which a source of a pressure wave is estimated by assuming that a pressure wave caused by pipe rupture concentrically spreads without depending on a pipeline network. NPL 5 describes a technique in which a point at which a difference between an arrival time difference of a pressure wave by sensor measurement and an arrival time difference of a pressure wave by computer simulation is smallest is estimated as a wave source of a pressure wave. NPL 6 describes a technique in which a point at which a difference between an arrival time difference of a pressure wave by sensor measurement and a propagation time difference of a pressure wave by computer simulation is smallest is efficiently searched by narrowing in a graphical and hierarchical manner, and the searched point is estimated as a wave source of a pressure wave.

### CITATION LIST

### Non Patent Literature

[NPL 1] Toyoo FUKUDA, Fault Detection of Water Pipe Line by Propagation Wave Theory, Transactions of the Society of Instrument and Control Engineers (SICE), Vol. 18, No. 10, 1982
[NPL 2] Makoto TSUKIYAMA, Estimation Method of Fault Location Area for Water Distribution Network Systems, Transactions of the Society of Instrument and Control Engineers (SICE), Vol. 23, No. 6, 1987
[NPL 3] Makoto MIYATA et al., Proposal of Leak Detection Method by Virtual Area Partitioning, Journal of the Society of Environmental Instrumentation Control and Automation (EICA), Vol. 17, No. 2-3, 2012
[NPL 4] Dai HATTORI et al., Technologies Achieving Energy Saving and Reduction of Operating Costs for Water Supply Systems, TOSHIBA REVIEW, vol 69, no 5, 2014
[NPL 5] Seshan Srirangarajan, Wavelet-based Burst Event Detection and Localization in Water Distribution Systems, Journal of Signal Processing Systems, Vol. 72, Issue 1, pp 1-16, 2013
[NPL 6] W. J. Hampson, et al., Transient source localization methodology and laboratory validation, International Conference on Computing and Control for the Water Industry (CCWI), Vol. 70, pp. 781-790, 2013

### SUMMARY OF INVENTION

### Technical Problem

The technique described in NPL 1 is directed to a single pipe. Specifically, the technique described in NPL 1 is not necessarily directed to a pipeline network in which a plurality of pipes are connected. The technique described in NPL 2 uses a flow rate of fluid flowing through a pipe in estimating a burst position. However, when a fault occurs in a pipe, a change by the fault may uniquely appear in a pressure, as compared with a flow rate. In other words, in the method using a flow rate of fluid flowing through a pipe, as described in NPL 2, it may be difficult to detect a small rupture or fault in a pipe. Further, in the techniques described in NPL 4 to NPL 6, a position of a wave source of a pressure wave is estimated based on an arrival time difference of a first wave of a pressure wave when the pressure wave is generated. However, the arrival time of the first wave may be affected by a determination criterion or noise, and may include an error.

In other words, in the techniques described in the NPLs, it may be difficult to accurately estimate a position where a pressure wave is generated by a small number of sensors in a pipeline network in which a plurality of pipes are connected in a complicated manner.

In order to solve the aforementioned inconveniences, a main object of the present invention is to provide a position estimation device and others which accurately estimate a position where a pressure wave is generated.

### Solution to Problem

A position estimation device according to an aspect of the present invention includes first cross-correlation derivation means for deriving a first cross-correlation relating to a measurement value based on the measurement values indicating a pressure of fluid flowing through a pipeline network and respectively measured at least at two positions in the pipeline network, second cross-correlation derivation means for deriving a second cross-correlation relating to a calculation value based on the calculation value obtained by respectively calculating the pressure of the fluid at least at the two positions in the pipeline network, and estimation means for estimating an occurrence position of a pressure wave in the pipeline network based on the first cross-correlation and the second cross-correlation.

A position estimation method according to an aspect of the present invention includes deriving a first cross-correlation relating to a measurement value based on the measurement value respectively obtained by measuring a pressure of fluid flowing through a pipeline network at least at two positions in the pipeline network, deriving a second cross-correlation relating to a calculation value based on the calculation value obtained by respectively calculating the pressure of the fluid at least at the two positions in the pipeline network, and estimating an occurrence position of a pressure wave based on the first cross-correlation and the second cross-correlation.

A computer-readable recording medium according to an aspect of the present invention non-transitorily stores a program causing a computer to execute a process of deriving a first cross-correlation relating to a measurement value based on the measurement value indicating a pressure of fluid flowing through a pipeline network and respectively measured at least at two positions in the pipeline network, a process of deriving a second cross-correlation relating to a calculation value based on the calculation value obtained by respectively calculating the pressure of the fluid at least at the two positions in the pipeline network, and a process of estimating an occurrence position of a pressure wave based on the first cross-correlation and the second cross-correlation.

### Advantageous Effects of Invention

According to the present invention, it is possible to provide a position estimation device and others which accurately estimate a position where a pressure wave is generated.

### BRIEF DESCRIPTION OF DRAWINGS

FIG. 1 is a diagram illustrating an example of a manner of propagation of a pressure wave through a pipeline network or the like;

FIG. 2 is a diagram illustrating a relation between a pressure wave relating to fluid flowing through a pipeline network and a cross-correlation thereof;

FIG. 3 is a diagram illustrating a position estimation device in a first example embodiment of the present invention;

FIG. 4 is a diagram illustrating a position estimation system in the first example embodiment of the present invention;

FIG. 5 is a diagram illustrating local peaks of a cross-correlation for use in estimating a position where a pressure wave is generated by the position estimation device in the first example embodiment of the present invention;

FIG. 6 is a flowchart illustrating an operation of the position estimation device in the first example embodiment of the present invention;

FIG. 7 is a diagram illustrating a position estimation device in a second example embodiment of the present invention;

FIG. 8 is a diagram illustrating an example of a case where a predicted position setting unit of the position estimation device in the second example embodiment of the present invention sets a position where a pressure wave is generated;

FIG. 9 is a diagram illustrating an example of a case where the position estimation device in the second example embodiment of the present invention searches a position where a pressure wave is generated in a pipeline network;

FIG. 10 is a diagram illustrating an example of an operation of the predicted position setting unit of the position estimation device in the second example embodiment of the present invention;

FIG. 11 is a diagram illustrating a position estimation device in a third example embodiment of the present invention;

FIG. 12 is a diagram illustrating an example of a case where there is a difference in the propagation velocity of a pressure wave in a pipeline network;

FIG. 13 illustrates another example of a case where there is a difference in the propagation velocity of a pressure wave in a pipeline network;

FIG. 14 illustrates an example of a cross-correlation relating to a combined wave of pressure waves whose propagation velocities are different in a pipeline network;

FIG. 15 is a schematic diagram illustrating an example of an operation of a first cross-correlation derivation unit 110 and a correlation separation unit 350 in the third example embodiment of the present invention; and

FIG. 16 is a diagram illustrating an example of an information processing device which implements the position estimation device in each of the example embodiments of the present invention.

### DESCRIPTION OF EMBODIMENTS

Example embodiments of the present invention are described with referring to the accompanying drawings. First, principles and others relating to position estimation of a pressure wave for use in the example embodiments of the present invention are described, and thereafter, the example embodiments of the present invention are described.

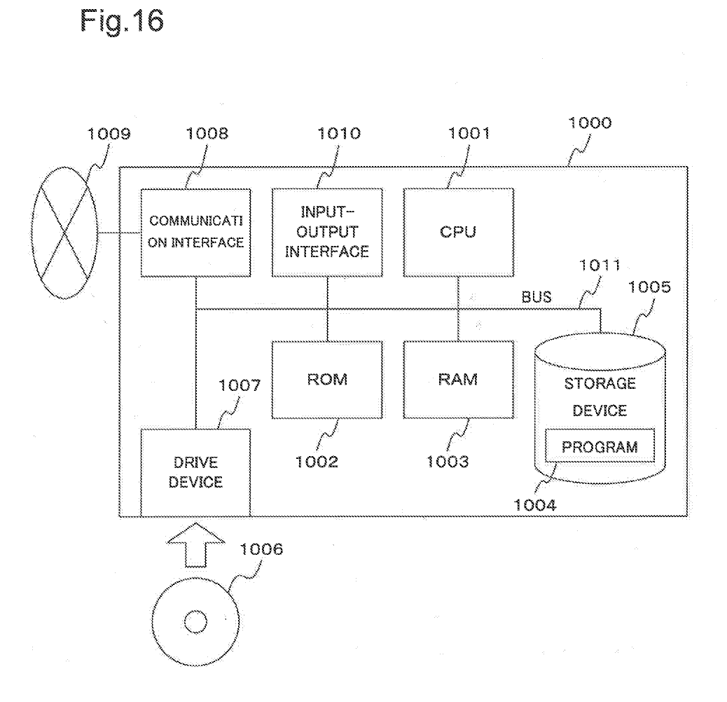

Note that in the example embodiments of the present invention, each constituent element of each device or a system indicates a block of a functional unit. A part or all of each constituent element of each device or a system is implemented by any combination of an information processing device 1000 and a program as illustrated in FIG. 16, for example. The information processing device 1000 includes the following configuration as an example:
a CPU (Central Processing Unit) 1001,
a ROM (Read Only Memory) 1002,
a RAM (Random Access Memory) 1003,
a program 1004 to be loaded on the RAM 1003,
a storage device 1005 which stores the program 1004,
a drive device 1007 which reads and writes with respect to a recording medium 1006,
a communication interface 1008 connected to a communication network 1009,
an input-output interface 1010 which inputs and outputs data, and
a bus 1011 which connects each of the constituent elements.

The constituent elements of the devices in each of the example embodiments are implemented by causing the CPU 1001 to acquire the program 1004 which implements the functions of these constituent elements. For example, the program 1004 which implements the functions of the constituent elements of the devices is stored in advance in the storage device 1005 or the RAM 1003. The CPU 1001 reads the program 1004 as necessary. Note that the program 1004 may be supplied to the CPU 1001 via the communication network 1009. Alternatively, the program 1004 may be stored in advance in the recording medium 1006, and may be supplied to the CPU 1001 by causing the drive device 1007 to read the program.

Various modifications are available as a method for implementing the devices. For example, the devices may be implemented by any combination of an individual information processing device 1000 and a program for each constituent element. Further, a plurality of constituent elements provided in each device may be implemented by any combination of one information processing device 1000 and a program.

Further, a part or all of the constituent elements of the devices is implemented by other general-purpose or dedicated circuit, a processor, or the like, or by combination of these elements. These elements may be constituted by a single chip, or may be constituted by a plurality of chips to be connected via a bus. A part or all of the constituent elements of the devices may be implemented by combination of the aforementioned circuit or the like, and a program.

When a part or all of the constituent elements of the devices is implemented by a plurality of information processing devices, circuits, or others, the plurality of information processing devices, circuits, or others may be centralized or may be distributed. For example, an information processing device, a circuit, or others may be implemented in a form of being connected to each other via a communication network, such as a client and server system, a cloud computing system, or the like.

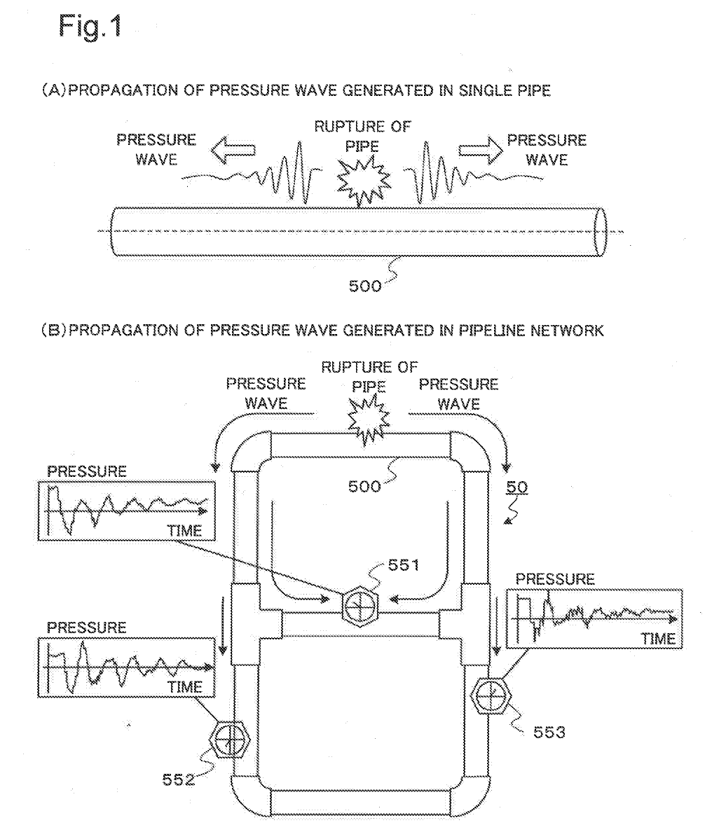

There are described principles and others relating to position estimation of a pressure wave used in the example embodiments of the present invention in the beginning. Firstly, there is described a manner of propagation of a pressure wave through a pipe and others by using FIG. 1.

FIG. 1(A) illustrates a manner of propagation of a pressure wave through a single pipe 500. In this example, it is assumed that a pressure wave is generated by a sudden change in the pressure of fluid caused by rupture of the pipe 500. The pressure wave propagates in two directions of the pipe 500 from a position where the pressure wave is generated through fluid flowing in the pipe 500 and the pipe 500 as a medium. Generally, it is known that a pressure wave propagating through fluid flowing through a pipe is less likely to attenuate than a pressure wave propagating through a pipe body of a pipe made of iron or resin as a main material.

On the other hand, FIG. 1(B) illustrates a manner of propagation of a pressure wave through a pipeline network 50 constituted by connecting pipes 500. In the example illustrated in FIG. 1(B), it is also assumed that a pressure wave is generated by a sudden change in the pressure of fluid caused by rupture of the pipe 500 constituting the pipeline network 50. Note that in the pipeline network 50, a position where a pressure wave is generated as described above is referred to as “a occurrence position of a pressure wave in a pipeline network”, or simply “a occurrence position of a pressure wave”. As illustrated in FIG. 1(B), a pressure wave generated at a certain point in the pipeline network 50 propagates to respective positions in the pipeline network 50 through fluid flowing in the pipe 500 constituting the pipeline network 50 and the pipes 500 as a medium. A pressure wave propagating to the respective positions in the pipeline network 50 are measured respectively by pressure meters 551 to 553 installed in the pipeline network 50. A pressure wave is measured by a pressure meter installed at a position close to the occurrence position of a pressure wave out of the pressure meters 551 to 553 at an early point of time after the pipe 500 is ruptured. Further, a pressure wave is measured by a pressure meter installed at a position far from an occurrence position of a pressure wave out of the pressure meters 551 to 553 at a point of time after a time depending on a distance from the occurrence position of the pressure wave is elapsed after the pipe 500 is ruptured.

In the example illustrated in FIG. 1(B), even when a point of time when a pressure wave is generated is unknown, it is possible to know the point of time when a first wave which reaches for the first time out of the pressure wave (hereinafter simply referred to as “a first wave”) is measured at each of the pressure meters 551 to 553. In other words, it is possible to measure a difference in time when a first wave is measured between the pressure meters 551 to 553. The difference in time changes depending on an occurrence position of a pressure wave.

On the other hand, it may be possible to know in advance a structure of each position in the pipeline network 50 (the length, the diameter, the thickness or other features of the pipe 500), and a propagation velocity of a pressure wave. In this case, it is possible to obtain an arrival time of a first wave at each of the pressure meters 551 to 553 or a difference between the arrival times relating to a pressure wave generated at any position by calculation such as computer simulation based on these pieces of information.

Further, it is possible to estimate an occurrence position of a pressure wave based on a difference between arrival times of a first wave respectively measured by the pressure meters 551 to 553, and an arrival time of a first wave obtained by calculation. For example, when an arrival time difference of a first wave obtained by measurement and an arrival time difference of a first wave obtained by calculation under an assumption that an freely-selected position is an occurrence position of a pressure wave satisfy a predetermined condition, it is possible to estimate the freely-selected position as an occurrence position of a pressure wave. The predetermined condition is such that the aforementioned two arrival time differences of a first wave coincide with each other, a difference between the two arrival time differences of a first wave is smallest, or other conditions.

However, in the aforementioned example, an error may be included in the arrival time of a first wave measured at each of the pressure meters 551 to 553. This is because a value to be measured by a pressure meter may generally include noise, or a first wave may be a wave trough or a wave crest, and thus it may not be easy to specify the first wave. Therefore, when an occurrence position of a pressure wave is estimated by the aforementioned method, accuracy on the estimated position of a pressure wave may be low.

Further, as another method for obtaining an arrival time difference of a pressure wave between a plurality of positions in a pipeline network, there is a method using a cross-correlation of two pressure waves. As an example, a cross-correlation C[k] between a signal x1[n] and a signal x2[n] is expressed by the following Equation (1). Note that k indicates a time index in a cross-correlation.

$$C [ k ] = \frac{{\sum }_{k = - N + 1}^{N - 1} ( x 1 [ n ] - \overline{x 1} ) ( x 2 [ n + k ] - \overline{x 2} )}{\sqrt{{\sum }_{n = 0}^{N - 1} {( x 1 [ n ] - \overline{x 1} )}^{2} \cdot {\sum }_{n = 0}^{N - 1} {( x 2 [ n ] - \overline{x 2} )}^{2}}} \qquad ( 1 )$$

(x̅1̅ and x̅2̅ respectively represents averages of x1 and x2)

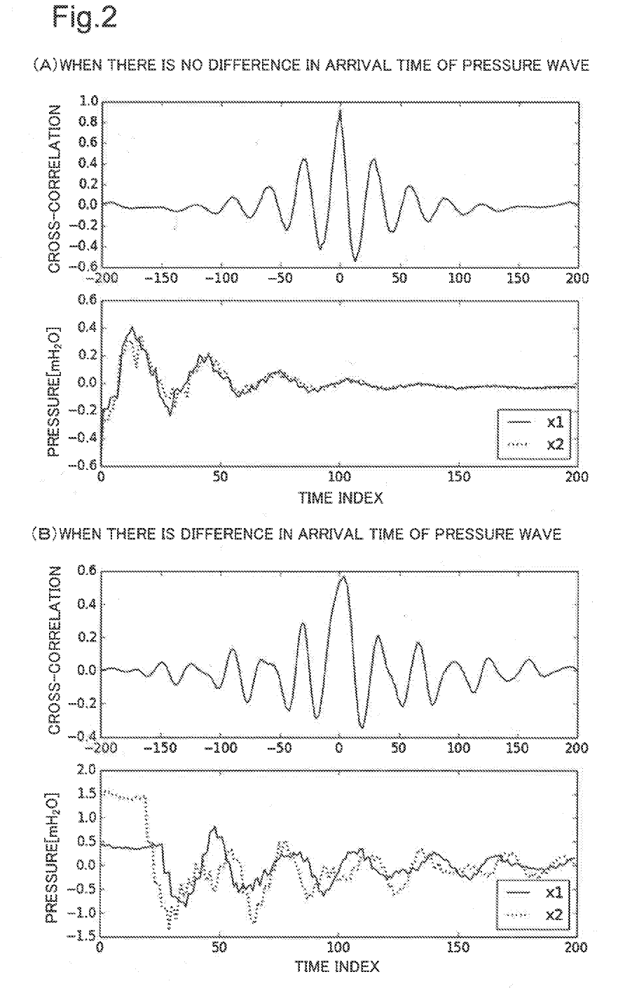

FIG. 2 is a diagram illustrating an example of a relation between an arrival time difference between pressure waves x1 and x2 measured at two positions in a pipeline network and a cross-correlation between the pressure waves. FIG. 2(A) illustrates an example of a cross-correlation and pressures when there is no arrival time difference between the pressure waves x1 and x2 at each measurement position (in other words, the pressure waves x1 and x2 arrive simultaneously). As illustrated in the example of FIG. 2(A), when there is no arrival time difference between pressure waves, the value of a cross-correlation is maximum when the time index k is 0.

Further, FIG. 2(B) illustrates an example of a cross-correlation and pressures when there is an arrival time difference between the pressure waves x1 and x2 at each measurement position (that is, the pressure waves x1 and x2 arrive at different time). When there is an arrival time difference between pressure waves as in this case, the value of a cross-correlation is maximum when the time index k is different from 0. In the example illustrated in FIG. 2(B), a cross-correlation between the pressure waves x1 and x2 is maximum when the time index k is +4. In other words, in the example illustrated in FIG. 2(B), the pressure wave x1 arrives at a time delayed from the arrival time of the pressure wave x2 by the time index 4. In this way, using a cross-correlation between pressure waves, it may become possible to obtain an arrival time difference between pressure waves at a plurality of positions in a pipeline network.

Further, as described above, when configuration information of the pipeline network 50 as illustrated in FIG. 1(B) is known, it is possible to obtain a propagation manner of a pressure wave generated by a sudden change in the pressure of fluid flowing through a pipe including rupture or others of a pipe by calculation based on hydromechanics. Configuration information of the pipeline network 50 includes, for instance, the length, the diameter, a roughness coefficient of an inner portion, and the thickness of each of the pipe 500 constituting the pipeline network 50, a velocity of a pressure wave propagating through fluid flowing through the pipes 500, and other information.

As a more detailed example of the aforementioned case, a propagation manner of a pressure wave is calculated by the following computer simulation. Specifically, it is assumed that a step-like pressure change occurs in fluid flowing through a pipe at any position in a pipeline network (a position assumed as described above is hereinafter referred to as “a predicted occurrence position of a pressure wave”). Further, a process of changing an internal pressure of a pipe at a position where a pressure meter is disposed in a pipeline network is simulated.

When a calculation value of a pressure wave in a pipeline network obtained by computer simulation or other methods as described above is compared with a measurement value of a pressure measured in the pipeline network, there is a case that an amplitude and a phase, which indicates a change in the pressure, do not completely coincide with each other. However, it is possible to obtain a calculation value of a pressure wave with accuracy necessary in analyzing an arrival time difference of a pressure wave at two positions in a pipeline network. Therefore, as far as a calculation value of a pressure wave is calculated, it is possible to obtain a cross-correlation between pressure waves at two positions in a pipeline network. Further, a calculation value of a pressure wave is obtained by calculation such as simulation. Therefore, it is possible to obtain a calculation value of a pressure wave, which is generated by rupture or the like of a pipe at any position in a pipeline network. Thus, it is possible to obtain a cross-correlation relating to a calculation value of a pressure wave at any of the two positions in a pipeline network.

### First Example Embodiment

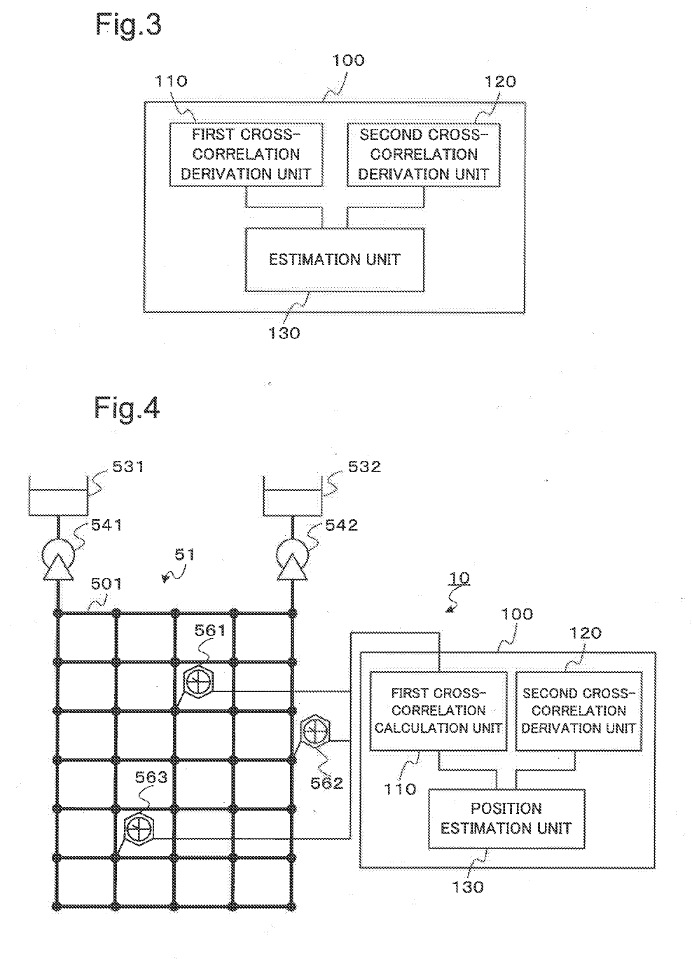

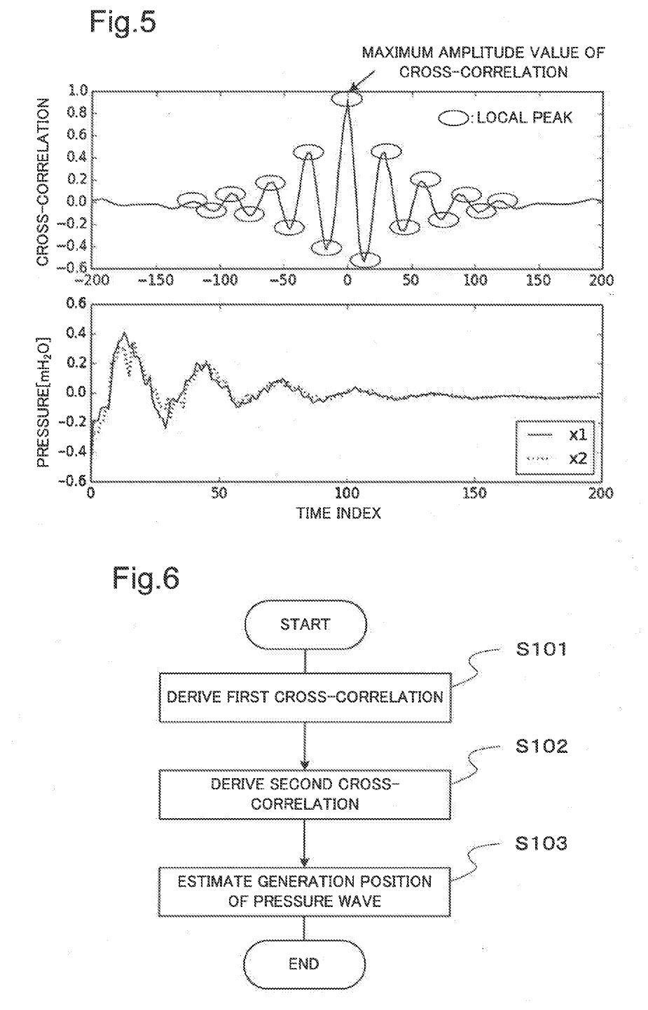

Next, the first example embodiment of the present invention will be described. FIG. 3 is a diagram illustrating a position estimation device in the first example embodiment of the present invention. FIG. 4 is a diagram illustrating a position estimation system in the first example embodiment of the present invention, and a pipeline network in which an occurrence position of a pressure wave is estimated with use of the position estimation system. FIG. 5 is a diagram illustrating local peaks of a cross-correlation for use in estimating an occurrence position of a pressure wave by the position estimation device in the first example embodiment of the present invention. FIG. 6 is a flowchart illustrating an operation of the position estimation device in the first example embodiment of the present invention.

As illustrated in FIG. 3, a position estimation device 100 in the first example embodiment of the present invention includes a first cross-correlation derivation unit 110, a second cross-correlation derivation unit 120, and an estimation unit 130. The first cross-correlation derivation unit 110 derives a first cross-correlation relating to measurement values based on the measurement values respectively obtained by measuring a pressure of fluid flowing through a pipeline network at least at two positions in the pipeline network. The second cross-correlation derivation unit 120 derives a second cross-correlation relating to calculation values based on the calculation values respectively obtained by calculating a pressure of the fluid at least at the two positions in the pipeline network. The estimation unit 130 estimates an occurrence position of a pressure wave based on the first cross-correlation and the second cross-correlation.

In the example embodiment, a position estimation system 10 including the position estimation device 100 is configured. FIG. 4 illustrates the position estimation system 10 in the first example embodiment of the present invention. The position estimation system 10 includes the position estimation device 100, and a plurality of pressure detection units 561 to 563. A pipeline network 51 in which an occurrence position of a pressure wave is estimated with use of the position estimation system 10 in the example embodiment includes a pipe 501, tanks 531 and 532, and pumps 541 and 542, for example. Each of the plurality of pressure detection units 561 to 563 measures a pressure of fluid flowing through the pipeline network 51. Each of the plurality of pressure detection units 561 to 563 uses a pressure meter of any type capable of measuring a pressure of fluid flowing through the pipeline network 51. Note that in FIG. 4, the number of the plurality of pressure detection units is three. However, the number of the pressure detection units is not limited, and may be a value other than three. The number of the plurality of pressure detection units may be changed as necessary depending on a configuration of a pipeline network where an occurrence position of a pressure wave is estimated. Further, the configuration of the pipeline network 51 illustrated in FIG. 4 is an example, and the example embodiment is not limited to the above. The position estimation system 10 in the example embodiment is capable of estimating an occurrence position of a pressure wave with respect to a pipeline network of any configuration different from the configuration of the pipeline network 51.

First, constituent elements of the position estimation device 100 in the example embodiment are described. As described above, the first cross-correlation derivation unit 110 derives a first cross-correlation relating to measurement values obtained by measuring a pressure of fluid flowing through a pipeline network. The measurement values are obtained by any means such as pressure meters which are disposed in a pipeline network to measure a pressure of fluid flowing through a pipe. In one example, the first cross-correlation derivation unit 110 calculates a cross-correlation with use of the aforementioned Equation (1).

As an example, the first cross-correlation derivation unit 110 derives a first cross-correlation Cref(m)[k] relating to combination of measurement values at any of the two positions from a pressure waveform representing measurement values to be measured at a plurality of positions in a pipeline network. In this case, m denotes the number of combinations, and takes one of the values from 1 to the total number M of combinations (where M is an integer of 1 or larger).

For example, when a first cross-correlation is used based on measurement values of a pressure measured at three positions (the position 1 to the position 3) in a pipeline network, the first cross-correlation derivation unit 110 derives a first cross-correlation Cref(m)[k] of ₃C₂=3 sets. In this case, combination of positions in a pipeline network is (the position 1 and the position 2), (the position 1 and the position 3), and (the position 2 and the position 3). Further, when a first cross-correlation is used based on measurement values of a pressure measured at four positions (the position 1 to the position 4) in a pipeline network, the first cross-correlation derivation unit 110 derives a first cross-correlation Cref(m)[k] of ₄C₂=6 sets. In this case, combination of positions in a pipeline network is (the position 1 and the position 2), (the position 1 and the position 3), (the position 1 and the position 4), (the position 2 and the position 3), (the position 2 and the position 4), and (the position 3 and the position 4).

Note that the first cross-correlation derivation unit 110 may derive a first cross-correlation regarding all of the total number M of combinations, or may obtain a first cross-correlation regarding a part of sets included in the total number M of combinations. The number of first cross-correlations to be obtained by the first cross-correlation derivation unit 110 is determined as necessary depending on an estimation method for use in estimating an occurrence position of a pressure wave by the estimation unit 130 to be described later, accuracy necessary in estimation, or the like.

As described above, the second cross-correlation derivation unit 120 derives a second cross-correlation relating to calculation values obtained by calculating a pressure of fluid flowing through a pipeline network. The calculation values are obtained by computer simulation or other methods, as explained above. As an example, the second cross-correlation derivation unit 120 calculates a cross-correlation with use of the aforementioned Equation (1) in the same manner as the first cross-correlation derivation unit 110. For example, the second cross-correlation derivation unit 120 sets freely-selected position in a pipeline network as a predicted occurrence position of a pressure wave, and derives a second cross-correlation Ccal(m)[k] relating to combination of calculation values respectively obtained by calculating a pressure wave at a plurality of freely-selected positions in the pipeline network different from the set position. Note that the aforementioned plurality of arbitrary positions in a pipeline network are positions where pressure meters are disposed in the pipeline network 51, for instance. Specifically, a second cross-correlation to be derived by the second cross-correlation derivation unit 120 is a value, which is predicted to be obtained when it is assumed that a pressure wave generated at a predicted occurrence position of a pressure wave that is appropriately determined is measured by a pressure meter disposed in a pipeline network. In this case, m denotes the number of combinations, and takes one of the values from 1 to the total number M of combinations (where M is an integer of 1 or larger).

The second cross-correlation derivation unit 120 may derive a second cross-correlation Ccal(m)[k] by setting an freely-selected position in a pipeline network as a predicted occurrence position of a pressure wave according to an estimation process by the estimation unit 130 to be described later. For example, the second cross-correlation derivation unit 120 may derive a second cross-correlation Ccal(m)[k] by setting a predicted occurrence position of a pressure wave to an arbitrary position in a pipeline network. Alternatively, the second cross-correlation derivation unit 120 may set one of a plurality of arbitrary different positions in a pipeline network as a predicted occurrence position of a pressure wave. In this case, in one example, the second cross-correlation derivation unit 120 derives a second cross-correlation Ccal(m)[k] when a pressure wave is generated at one of a plurality of freely-selected different positions in the pipeline network for each position.

Further, the second cross-correlation derivation unit 120 may obtain a second cross-correlation Ccal(m)[k] by calculation as necessary each time when the value of the second cross-correlation Ccal(m)[k] is used. Alternatively, the second cross-correlation derivation unit 120 may store a value of a second cross-correlation Ccal(m)[k] obtained in advance by calculation in unillustrated storage means or others, and may refer to the stored value as necessary.

The estimation unit 130 estimates an occurrence position of a pressure wave in a pipeline network based on the first cross-correlation and the second cross-correlation. In one example, the estimation unit 130 estimates an occurrence position of a pressure wave based on a difference between a first cross-correlation and a second cross-correlation. In other words, the estimation unit 130 estimates an occurrence position of a pressure wave in a pipeline network based on an assumption that the smaller a difference between a first cross-correlation and a second cross-correlation is, the closer the position determined to be a predicted occurrence position of a pressure wave by the second cross-correlation is with respect to an occurrence position of a pressure wave in an actual pipeline network.

As a specific example of the estimation method, the estimation unit 130 estimates an occurrence position of a pressure wave based on a difference between a first cross-correlation Cref(m)[k] and each of a plurality of second cross-correlations Ccal(m)[k] obtained by changing a predicted occurrence position of a pressure wave. In other words, the estimation unit 130 sets a predicted occurrence position of a pressure wave, which is set in relation to a second cross-correlation Ccal(m)[k] at which a difference (an error) between two cross-correlations satisfies a predetermined condition, as an occurrence position of a pressure wave in an actual pipeline network. In this case, the predetermined condition is such that, for instance, a difference between two cross-correlations is smaller than a predetermined difference, or a difference between two cross-correlations is smallest with respect to the aforementioned plurality of second cross-correlations Ccal(m)[k]. By setting a condition as described above, the estimation unit 130 can estimate an occurrence position of a pressure wave in a pipeline network.

A generalized formula for obtaining a difference (an error) between a first cross-correlation Cref(m)[k] and a second cross correlation Ccal(m)[k] is expressed by Equation (2). The estimation unit 130 obtains the difference between two cross-correlations with the use of Equation (2). Alternatively, the estimation unit 130 may obtain a difference e between two cross-correlations by a method other than the above.

In Equation (2), a function g(x,y) indicates a function for converting x and y into a value for obtaining a difference. Further, in Equation (2), K indicates a value range being an allowable range of k. For instance, the function g(x,y) and the value range K are determined as follows.

Specifically, the following equations (g1) to (g3) are used as the function g(x,y).

g(x,y)=(x−y)*(x−y) (g1)

g(x,y)=|x−y| (g2)

g(x,y)=table reference(|x−y|) (g3)

Note that in these equations, the symbol “*” denotes multiplication. Further, the symbol “ ” denotes an absolute value of an equation defined therein.

In the aforementioned equations, the equation (g1) represents a square of a difference between x and y. Further, the equation (g2) represents an absolute value of a difference between x and y. The equation (g3) represents a value obtained by table reference based on a value of a difference between x and y. Specifically, the equation (g3) returns an output value based on a table or others which is determined in advance with respect to a relation between an input value and an output value. Any format can be used for table reference used in the equation (g3). For instance, the table may include any mathematical expression. By referring to a table as necessary, the equation (g3) can convert a value exceeding a predetermined upper limit value or lower limit value into a predetermined value, and quantize an input value. A table for use in the equation (g3) is determined as appropriate based on a condition in a pipeline network, a magnitude of a generated pressure wave, estimation accuracy on an occurrence position of a required pressure wave, or the like.

Specifically, the value range K is determined by the following equation (k1) or (k2).

K=[−N+1,N−1] (k1)

K=local Peaks(Cref(m)) (k2)

In the aforementioned equations, the value range (k1) represents an integer in a designated range. Specifically, when the value range K is expressed by the value range (k1), the estimation unit 130 estimates an occurrence position of a pressure wave based on first and second cross-correlations obtained from a pressure wave at a time index in the range expressed by the equation (k1). Further, the value range (k2) represents local peaks of a cross-correlation (Cref(m)). Note that the local peak indicates a point at which the gradient of a curve is zero, such as a wave crest or a wave trough in a waveform representing a cross-correlation. In a cross-correlation between waveforms x1 and x2 as illustrated in FIG. 5, the local peaks are points surrounded by circles in a cross-correlation waveform illustrated in FIG. 5. By limiting the value range K to local peaks of a cross-correlation Cref(m) as exemplified by the value range (k2), the estimation unit 130 come to estimate an occurrence position of a pressure wave based on a difference relating to a specific target point in first and second local correlations.

Note that the function local Peaks (Cref(m)) may have a format capable of indicating local peaks that satisfy a predetermined condition. Examples of the predetermined condition are such that an absolute value of an amplitude of a local peak is 50% or more of an absolute value of a maximum amplitude in a cross-correlation, or an absolute value of an amplitude of a local peak is within a third largest value from the maximum value of the absolute value out of amplitudes of local peaks.

Next, an operation of the position estimation device 100 in the first example embodiment of the present invention will be described using FIG. 6.

First, the first cross-correlation derivation unit 110 derives a first cross-correlation (Step S101). In this step, the first cross-correlation derivation unit 110 may use a measurement value which is measured in advance and is stored in storage means or other means, or a measurement value measured in performing this step. Further, the first cross-correlation derivation unit 110 may obtain the first cross-correlation relating to a pressure waveform including an excessive pressure wave when the excessive pressure wave is measured by a pressure meter for measuring a pressure in a pipeline network continuously, for instance, constantly or at a fixed time interval.

Subsequently, the second cross-correlation derivation unit 120 derives a second cross-correlation (Step S102). In this case, the second cross-correlation derivation unit 120 sets a predicted occurrence position of a pressure wave to a required position in a pipeline network and derives the second cross-correlation so that an estimation for an occurrence position of a pressure wave in the pipeline network in a later step may be eased, for example.

Note that Step S101 and Step S102 may be executed in an order different from the aforementioned order. Specifically, the operation of Step S102 may be executed prior to the operation of Step S101. Alternatively, the timing of executing the operations of the two steps may be overlapped in such a way that Step S101 and Step S102 are concurrently performed.

Subsequently, the estimation unit 130 estimates an occurrence position of a pressure wave (Step S103). For example, information relating to the estimated position of a pressure wave may be stored in a storage device (not illustrated), or may be output to an external device via a communication network, display means (not illustrated), or other means. The estimation unit 130 may indicate a position or a range in a pipeline network, which is estimated to be the estimated position of a pressure wave, as information relating to an occurrence position of a pressure wave. Further, the estimation unit 130 may indicate whether a specific position or range in a pipeline network is estimated to be an occurrence position of a pressure wave, as information relating to an occurrence position of a pressure wave.

As described above, the estimation unit 130 may estimate an occurrence position of a pressure wave based on a difference between a first cross-correlation and each of a plurality of second cross-correlations obtained by shifting a predicted occurrence position of a pressure wave. In this case, in one example, the estimation unit 130 determines whether a difference between the first cross-correlation and each of the plurality of second cross-correlations satisfies a predetermined condition. Further, the estimation unit 130 can set a predicted occurrence position of a pressure wave, which is set in relation to the second cross-correlation at which the aforementioned difference satisfies the predetermined condition, as an occurrence position of a pressure wave in a pipeline network.

Note that when the estimation unit 130 determines that the aforementioned difference does not satisfy the predetermined condition with respect to any of the plurality of second cross-correlations, the position estimation device 100 may return to Step S102, and may repeat the process. In this case, in Step S102, as an example, the second cross-correlation derivation unit 120 sets a position different from a position set in a previous step as the predicted occurrence position of a pressure wave, and derives a second cross-correlation.

As described above, the position estimation device 100 in the first example embodiment of the present invention estimates an occurrence position of a pressure wave based on the aforementioned first cross-correlation and second cross-correlation. The position estimation device 100 in the example embodiment estimates an occurrence position of a pressure wave based on a measurement value and a calculation value relating to an arrival time difference between pressure waves. Therefore, the position estimation device 100 in the example embodiment may enable an estimation of an occurrence position of a pressure wave based on measurement values measured by a small number of pressure meters. Further, the position estimation device 100 in the example embodiment estimates an occurrence position of a pressure wave based on a cross-correlation relating to each of a measurement value and a calculation value of a pressure wave. By using a cross-correlation, the position estimation device 100 may enable to obtain an arrival time difference between pressure waves in a pipeline network easily and accurately. Consequently, it is possible to improve estimation accuracy relating to an occurrence position of a pressure wave by the position estimation device 100. Therefore, the position estimation device 100 in the first example embodiment of the present invention can accurately estimate an occurrence position of a pressure wave.

(Modification of First Example Embodiment)

Various modifications can be proposed for the position estimation device 100 in the example embodiment. For example, the position estimation device 100 in the example embodiment may also use an index other than a pressure. As an example, the position estimation device 100 in the example embodiment may use information relating to vibration of a pipeline network detected by a vibration sensor or other devices together. In this case, for instance, the position estimation device 100 in the example embodiment estimates an occurrence position of a pressure wave by obtaining a cross-correlation relating to each of a pressure and vibration, and obtains a position which is eventually estimated to be an occurrence position of a pressure wave based on the two estimation results.

Further, the position estimation device 100 in the example embodiment may use configuration information (such as the length, the diameter, a roughness coefficient of an inner portion, and the thickness of a pipe, and a velocity of a pressure wave propagating through fluid flowing through the pipes 500) of a pipeline network in which an occurrence position of a pressure wave is estimated.

In this case, for example, the second cross-correlation derivation unit 120 sets a position at which a fault or rupture of a pipe is highly likely to occur as a predicted occurrence position of a pressure wave based on the aforementioned configuration information of a pipeline network, and derives a second cross-correlation. Further, for instance, when a plurality of positions are estimated as an occurrence position of a pressure wave, the estimation unit 130 can estimate a position at which a fault or rupture of a pipe is likely to occur as an occurrence position of a pressure wave in a pipeline network based on the aforementioned configuration information of a pipeline network.

Further, in the position estimation device 100 of the example embodiment, the first cross-correlation derivation unit 110, the second cross-correlation unit 120, and the estimation unit 130 may be respectively implemented as individual devices. In this case, the individual devices are respectively connected by an unillustrated wired or wireless communication network or the like.

### Second Example Embodiment

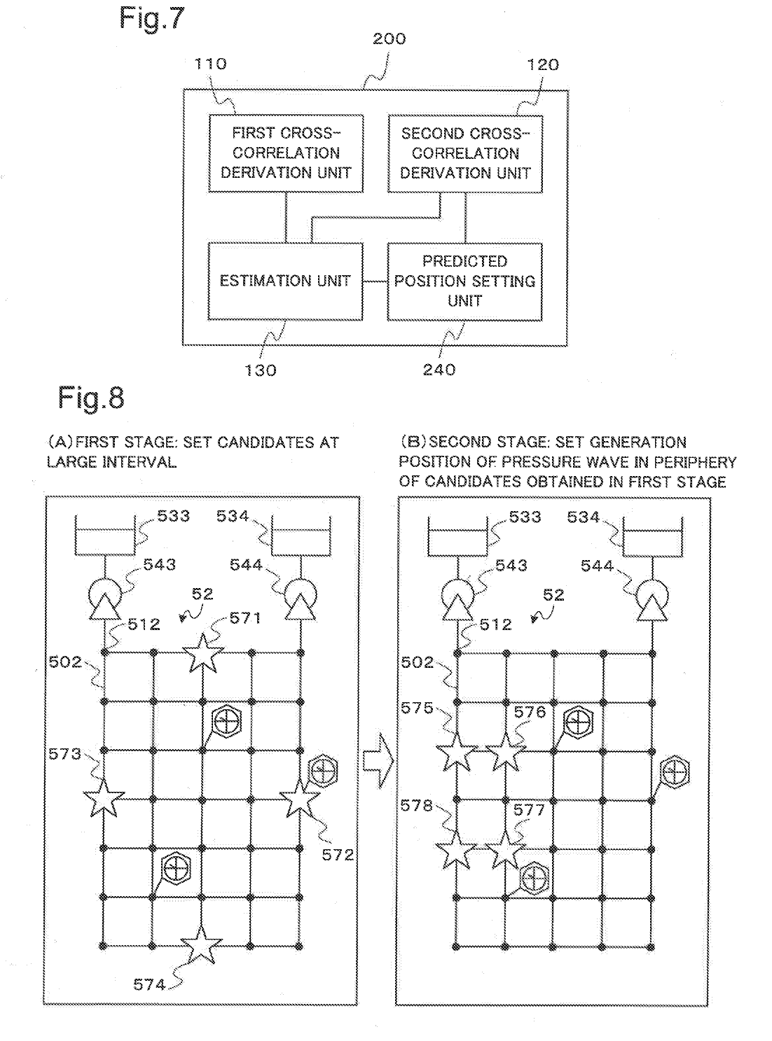

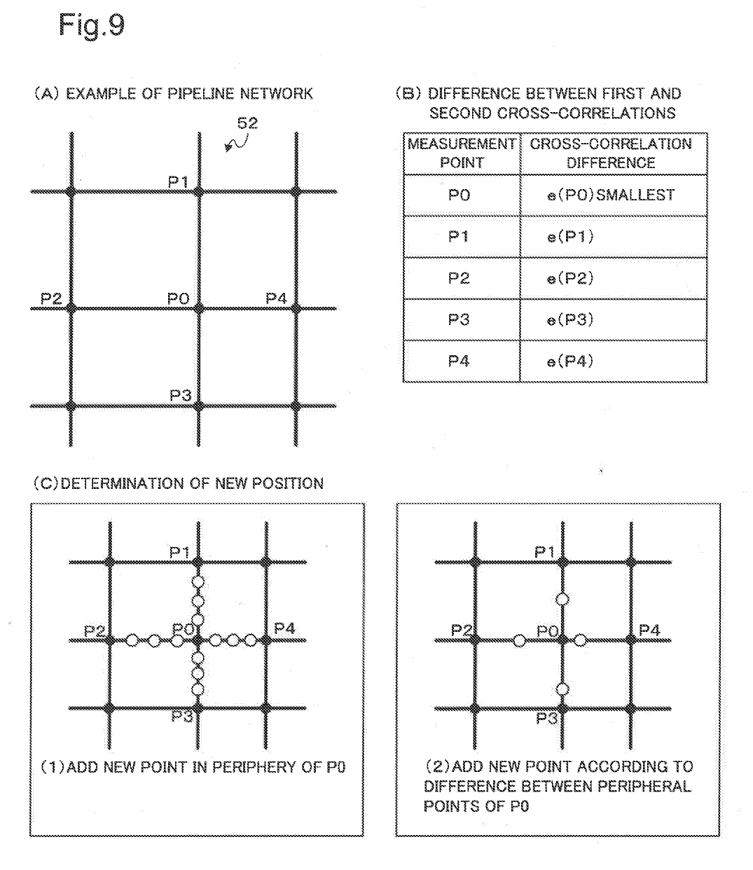

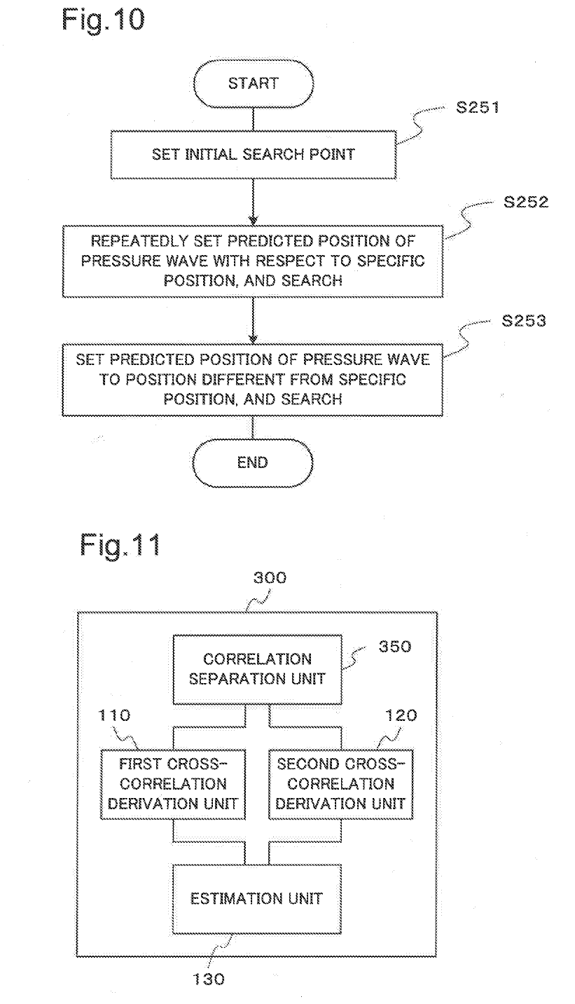

Next, the second example embodiment of the present invention will be described. FIG. 7 is a diagram illustrating a position estimation device in the second example embodiment of the present invention. FIG. 8 is a diagram illustrating an example of a case where a predicted position setting unit of the position estimation device in the second example embodiment of the present invention sets a predicted occurrence position of a pressure wave. FIG. 9 is a diagram illustrating an example of a case where a predicted occurrence position of a pressure wave in a pipeline network is searched by the position estimation device in the second example embodiment of the present invention. FIG. 10 is a diagram illustrating an example of an operation of the predicted position setting unit of the position estimation device in the second example embodiment of the present invention.

As illustrated in FIG. 7, a position estimation device 200 in the second example embodiment of the present invention includes a first cross-correlation derivation unit 110, a second cross-correlation derivation unit 120, a predicted position setting unit 240, and an estimation unit 130. The predicted position setting unit 240 repeatedly sets a predicted occurrence position of a pressure wave at which a pressure of fluid is calculated by the second cross-correlation derivation unit 120. Regarding configurations other than the above, the position estimation device 200 in the second example embodiment of the present invention includes the same configuration as the position estimation device 100 in the first example embodiment of the present invention.

Note that a position estimation system 20 including the position estimation device 200 in the example embodiment is configured in the same manner as the position estimation system 10 in the first example embodiment of the present invention.

As described in the position estimation device 100 in the first example embodiment of the present invention, the second cross-correlation derivation unit 120 may set a predicted occurrence position of a pressure wave to a plurality of arbitrary positions in a pipeline network and derive a second cross-correlation. In this case, the predicted occurrence position of a pressure wave to be set by the second cross-correlation derivation unit 120 may be repeatedly set a plurality of times by shifting a position in a pipeline network in such a manner that a difference between first and second cross-correlations is reduced.

In the position estimation device 200 of the example embodiment, the predicted position setting unit 240 repeatedly sets a predicted occurrence position of a pressure wave in the second cross-correlation derivation unit 120. For example, an occurrence position of a pressure wave in a pipeline network is accurately estimated by causing the predicted position setting unit 240 to repeatedly set a predicted occurrence position of a pressure wave in the second cross-correlation derivation unit 120 based on a result estimated by the estimation unit 130.

(Setting of Predicted Occurrence Position of Pressure Wave to Specific Position)

The predicted position setting unit 240 repeatedly sets a predicted occurrence position of a pressure wave when the second cross-correlation derivation unit 120 derives a second cross-correlation by various arbitrary methods. A repetition method for use in this case is, for instance, as a method for setting a predicted occurrence position of a pressure wave, a hierarchical search, a gradient method search, an optimum solution search method using a graph theory, and a random selection search method. As an example of this case, the predicted position setting unit 240 sets at least one of a plurality of predetermined specific positions in a pipeline network as a predicted occurrence position of a pressure wave in deriving a second cross-correlation. Further, for example, the aforementioned specific position may be an intersection point at which a plurality of pipes intersect each other in a pipeline network.

FIG. 8 is a diagram illustrating an example of a case where the predicted position setting unit 240 sets a predicted occurrence position of a pressure wave by the aforementioned hierarchical search. In FIG. 8, a pipeline network 52 includes a plurality of pipes 502 represented by straight lines in the figure, tanks 533 and 534, and pumps 543 and 544. Further, the plurality of pipes 502 are respectively connected at a plurality of branch points 512 represented by black circles in FIG. 8. In a hierarchical search described in this example, the predicted position setting unit 240 sets an occurrence position of a pressure wave to one of the plurality of branch points 512 as the specific position.

In this example, as a first stage, the predicted position setting unit 240 sets each of intersection points 571 to 574 in pipes indicated by star marks in FIG. 8(A) as the predicted occurrence position of a pressure wave in deriving a second cross-correlation by the second cross-correlation derivation unit 120. The second cross-correlation derivation unit 120 derives a second cross-correlation by setting each of the intersection points 571 to 574 as the predicted occurrence position of a pressure wave.

In this stage, each of the intersection points 571 to 574 is set to an intersection point at which a plurality of pipes intersect each other. Further, the estimation unit 130 estimates an occurrence position of a pressure wave in a pipeline network based on a first cross-correlation derived by the second cross-correlation derivation unit 110, and the second cross-correlation derived by setting each of the intersection points 571 to 574 as the predicted occurrence position of a pressure wave. In this example, for instance, the estimation unit 130 estimates that the intersection point 573 is closest to an occurrence position of a pressure wave in an actual pipeline network.

Subsequently, as a second stage, the predicted position setting unit 240 sets each of intersection points 575 to 578 in pipes indicated by star marks in FIG. 8(B) as a predicted occurrence position of a pressure wave in deriving a second cross-correlation by the second cross-correlation derivation unit 120. The second cross-correlation derivation unit 120 derives the second cross-correlation by setting each of the intersection points 575 to 578 as a predicted occurrence position of a pressure wave.

In this stage as well, each of the intersection points 575 to 578 is set to an intersection point at which a plurality of pipes intersect each other. Each of the intersection points 575 to 578 is set to a closer position in a pipeline network, as compared with each of the intersection points 571 to 574. Each of the intersection points 575 to 578 is set to a position close to the intersection point 573, which is estimated to be closest to an occurrence position of a pressure wave in a pipeline network in the first stage. Further, the estimation unit 130 estimates an occurrence position of a pressure wave in a pipeline network based on a first cross-correlation derived by the second cross-correlation derivation unit 110, and the second cross-correlation derived by setting each of the intersection points 575 to 578 as a predicted occurrence position of a pressure wave.

As described in the aforementioned example, the predicted position setting unit 240 repeatedly sets the predicted occurrence position of a pressure wave while shifting the predicted position by the second cross-correlation derivation unit 120. By repeatedly performing estimation while narrowing the estimated occurrence positions of a pressure wave in a pipeline network, the position estimation device 200 in the example embodiment can estimate an occurrence position of a pressure wave rapidly and with high accuracy.

(Setting of Predicted Occurrence Position of Pressure Wave to Position Different from the Specific Position)

Further, as another example, the position estimation device 200 in the example embodiment may obtain an occurrence position of a pressure wave in further detail, when the position estimation device 200 derives a second cross-correlation relating to the aforementioned specific position and estimates the occurrence position of a pressure wave. In this case, the predicted position setting unit 240 sets a predicted occurrence position of a pressure wave in further deriving a second cross-correlation at a position different from the aforementioned specific position based on the estimated position of a pressure wave.

In the previous example relating to setting of a predicted occurrence position of a pressure wave, a predicted occurrence position of a pressure wave is set to a predetermined specific position by the predicted position setting unit 240. Specifically, the predicted occurrence position of a pressure wave is set to an intersection point of a plurality of pipes. In this case, an occurrence position of a pressure wave in a pipeline network to be estimated by the estimation unit 130 is the set intersection point of pipes.

However, in an actual pipeline network, a fault or rupture of a pipe may occur at a position different from an intersection point of pipes. In other words, an occurrence position of a pressure wave in a pipeline network may be a position different from an intersection point of pipes. In this case, in the aforementioned example, the predicted position setting unit 240 further sets a predicted occurrence position of a pressure wave in deriving a second cross-correlation in order to search whether or not an actual occurrence position of a pressure wave in a pipeline network is located at a position different from an intersection point at the extending pipe.

FIG. 9 is a diagram illustrating an example of a case where a predicted occurrence position of a pressure wave in a pipeline network is searched in the aforementioned example. In the pipeline network illustrated in FIG. 9(A), a plurality of pipes are connected at intersection points including at least intersection points P0 to P4. There is assumed a case where the second cross-correlation derivation unit 120 derives a second cross-correlation by setting each of the intersection points P0 to P4 as a predicted occurrence position of a pressure wave based on an assumption that at least the intersection points P0 to P4 are candidate occurrence positions of a pressure wave. Further, as illustrated in FIG. 9(B), it is assumed that a difference between a first cross-correlation and a second cross-correlation is smallest at the intersection point P0, and that the estimation unit 130 estimates that the intersection point P0 is an occurrence position of a pressure wave in a pipeline network. In other words, in this example, an actual occurrence position of a pressure wave in a pipeline network is highly likely to exist at the intersection point P0 or in the vicinity thereof.

In this case, the predicted position setting unit 240 sets a predicted occurrence position of a pressure wave in deriving a second cross-correlation by the second cross-correlation derivation unit 120 to a position different from the aforementioned specific position based on the position of the intersection point P0. In the example of FIG. 9, the predicted position setting unit 240 sets an occurrence position of a pressure wave in a pipe between the intersection point P0 and each of the intersection points P1 and to P4 being intersection points on a pipe different from the pipe to be connected to the intersection point P0.

The second cross-correlation derivation unit 120 derives a second cross-correlation by setting the position set by the predicted position setting unit 240 as a predicted occurrence position of a pressure wave. Further, the estimation unit 130 estimates an occurrence position of a pressure wave in a pipeline network based on a difference between first and second cross-correlations at the arbitrary position. For instance, when a difference between first and second cross-correlations at the arbitrary position is smaller than a difference between first and second cross-correlations at the intersection point P0, the estimation unit 130 sets the arbitrary position as an occurrence position of a pressure wave in a pipeline network. According to the aforementioned configuration, the position estimation device 200 in this example can estimate an occurrence position of a pressure wave with enhanced accuracy.

In this example, the predicted position setting unit 240 determines the aforementioned arbitrary position by various methods. For example, the predicted position setting unit 240 sets the aforementioned arbitrary position as a predicted occurrence position of a pressure wave in deriving a second cross-correlation by the second cross-correlation derivation unit 120, as illustrated in FIG. 9(C).

In this example, as illustrated in (1) of FIG. 9(C), the predicted position setting unit 240 sets one or more new positions set in a pipe between the intersection point P0 and each of the intersection points P0 to P4 in the periphery thereof, as the predicted occurrence position of a pressure wave. In the example illustrated in (1) of FIG. 9(C), three new positions indicated by hollow circles in FIG. 9(C) are set between the intersection point P0 and each of the intersection points P1 to P4. The second cross-correlation derivation unit 120 derives a second cross-correlation relating to these positions.

Further, the estimation unit 130 estimates an occurrence position of a pressure wave in a pipeline network based on a difference between a first cross-correlation and each of the second cross-correlations derived as described above. In this case, the estimation unit 130 may set a position at which a difference between a first cross-correlation and each of second cross-correlations is smallest, as an occurrence position of a pressure wave in a pipeline network, out of one or more new positions at which a second cross-correlation is set.

Further, as described in an example illustrated in (2) of FIG. 9(C), the predicted position setting unit 240 sets a position, which is newly set in a pipe depending on a ratio of a difference between first and second cross-correlations relating to the intersection point P0 and each of the intersection points P1 to P4, as the predicted occurrence position of a pressure wave. In the example illustrated in (2) of FIG. 9(C), new positions indicated by hollow circles in FIG. 9(C) are set depending on a ratio of a difference between the first and the second cross-correlations relating to the point P0 and each of the points P1 to P4. The second cross-correlation derivation unit 120 derives a second cross-correlation by setting these positions as a new predicted occurrence position of a pressure wave.

In this example, when a ratio of a difference between the first and the second cross-correlations relating to the intersection point P0 and each of the peripheral intersection points is large (a difference between differences is large), a new position is set in the vicinity of the intersection point P0, as exemplified by a position set in a pipe between P0 and P4, for instance. When a ratio of a difference between the first and the second cross-correlations relating to the intersection point P0 and each of the peripheral intersection points is small (a difference between differences is small), the new position is set at a position in the vicinity of the peripheral intersection points, as exemplified by a position set in a pipe between P0 and P3, for instance.

Further, in this case as well, the estimation unit 130 estimates an occurrence position of a pressure wave in a pipeline network based on a difference between a first cross-correlation and each of the second cross-correlations derived as described above. In this case, the estimation unit 130 also sets a position at which a difference between a first cross-correlation and each of second cross-correlations is smallest as the occurrence position of a pressure wave in a pipeline network, out of newly set predicted positions of a pressure wave in deriving a second cross-correlation.

(Combination of Setting Methods Relating to Predicted Occurrence Positions of Two Pressure Waves)

The aforementioned operation examples of the position estimation device 200 in the example embodiment can be combined and used. An example of an operation of the predicted position setting unit 240 in obtaining a predicted occurrence position of a pressure wave in a pipeline network with use of the position estimation device 200 is illustrated as exemplified in FIG. 10, for example.

In the operation example illustrated in FIG. 10, first, the predicted position setting unit 240 sets a predicted occurrence position of a pressure wave in deriving a second cross-correlation for the first time by the second cross-correlation derivation unit 120 as an initial search point (Step S251). In this case, a plurality of initial search points are set from a predetermined specific position. The initial search points are set as follows, for example.
Always select a predetermined position in a pipeline network as the initial search point.
Randomly select a position serving as an initial search point from candidate positions in a pipeline network as the initial search point.
Determine the initial search point based on a position of a pressure meter which detects a pressure wave of which an occurrence position is specified first.

When an initial search point is set, the occurrence position of a pressure wave in a pipeline network is estimated by setting the initial search point as a predicted occurrence position of a pressure wave in deriving a second cross-correlation by the second cross-correlation derivation unit 120. In this case, the constituent elements of the position estimation device 200 estimate the occurrence position of a pressure wave in a pipeline network in the same manner as the operations of Step S101 to Step S103 illustrated in FIG. 6.

Subsequently, the predicted position setting unit 240 sets a predicted occurrence position of a pressure wave in deriving a second cross-correlation by the second cross-correlation derivation unit 120 based on an occurrence position of a pressure wave estimated in previous Step S251 (Step S252). In this case, the predicted position setting unit 240 sets the predicted occurrence position of a pressure wave by various methods as described above. Further, the predicted position setting unit 240 selects and sets the predicted occurrence position of a pressure wave from the aforementioned specific position in such a manner that at least one position is different from a plurality of predicted occurrence positions of a pressure wave set before. When the predicted occurrence position of a pressure wave is set in deriving a second cross-correlation by the second cross-correlation derivation unit 120, an occurrence position of a pressure wave in a pipeline network is estimated by the constituent elements of the position estimation device 200.

Note that the predicted position setting unit 240 may perform Step S252 only one time as illustrated in FIG. 10, or may repeatedly perform Step S252 a plurality of times based on an estimation result relating to an occurrence position of a pressure wave. Further, when the predicted occurrence position of a pressure wave in deriving a second cross-correlation is set, the constituent elements of the position estimation device 200 estimates an occurrence position of a pressure wave in a pipeline network as appropriate.

Next, the predicted position setting unit 240 sets a predicted occurrence position of a pressure wave in deriving a second cross-correlation by the second cross-correlation derivation unit 120 to a position different from the aforementioned specific position based on the occurrence position of a pressure wave estimated in Step S252 (Step S253).

In this case, the predicted position setting unit 240 sets the predicted occurrence position of a pressure wave in deriving a second cross-correlation to a position different from the aforementioned specific position based on the occurrence position of a pressure wave in a pipeline network which is estimated in a previous step. Further, as described above, the predicted position setting unit 240 may set a plurality of positions as a position different from the aforementioned specific position.

As described above, in the position estimation device 200 in the second example embodiment of the present invention, the predicted position setting unit 240 repeatedly sets a predicted occurrence position of a pressure wave at which a pressure of fluid is calculated by the second cross-correlation derivation unit 120. In the example embodiment, the predicted position setting unit 240 repeatedly sets the predicted occurrence position of a pressure wave in deriving a second cross-correlation based on an occurrence position of a pressure wave in a pipeline network estimated by the estimation unit 130. Therefore, the position estimation device 200 in the example embodiment can rapidly estimate an occurrence position of a pressure wave in a pipeline network. Further, in the example embodiment, the predicted position setting unit 240 repeatedly sets a predicted occurrence position of a pressure wave in deriving a second cross-correlation based on a position in the vicinity of a position, at which a pressure wave is actually highly likely to occur in a pipeline network. Therefore, the position estimation device 200 in the example embodiment can accurately estimate an occurrence position of a pressure wave in a pipeline network. Therefore, the position estimation device 200 in the example embodiment can estimate an occurrence position of a pressure wave at a rapidly and with high accuracy.

Note that the configuration of the position estimation device 200 in the example embodiment can be combined with the modification of the position estimation device 100 in the first example embodiment as necessary.

### Third Example Embodiment

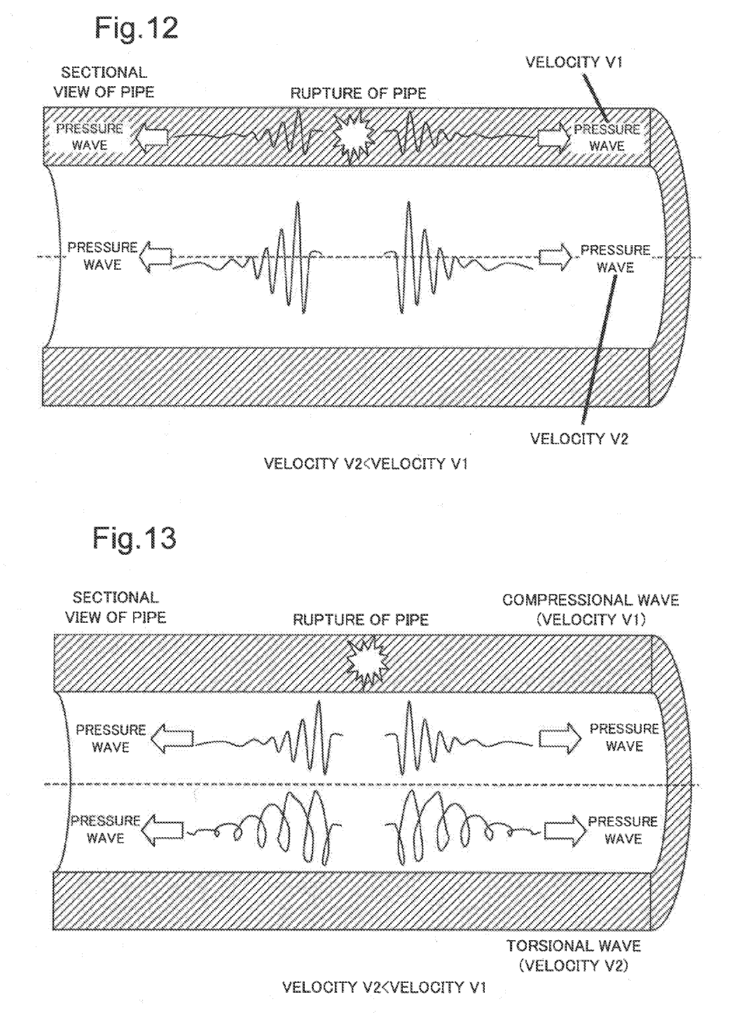

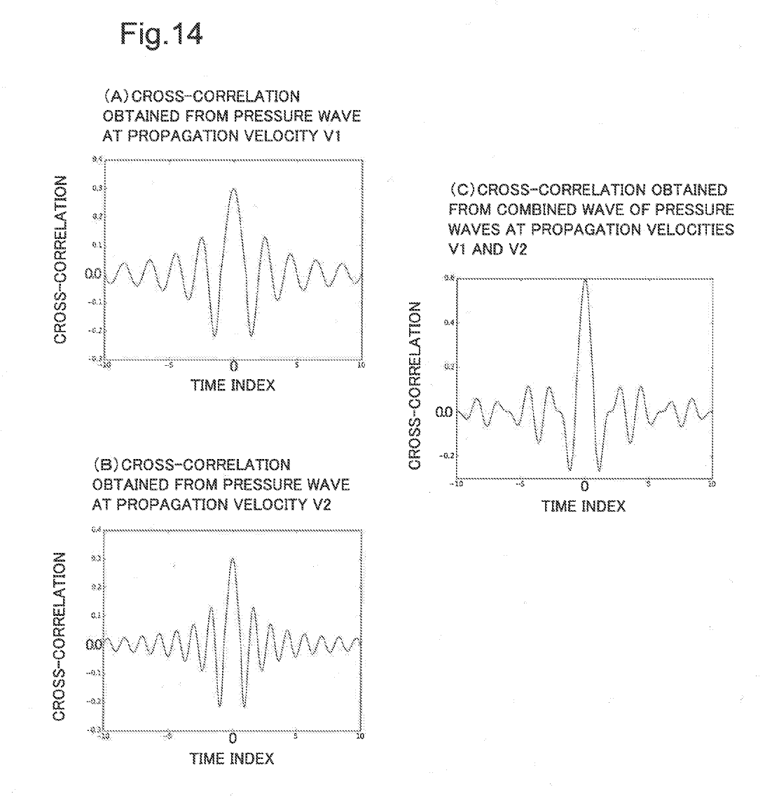

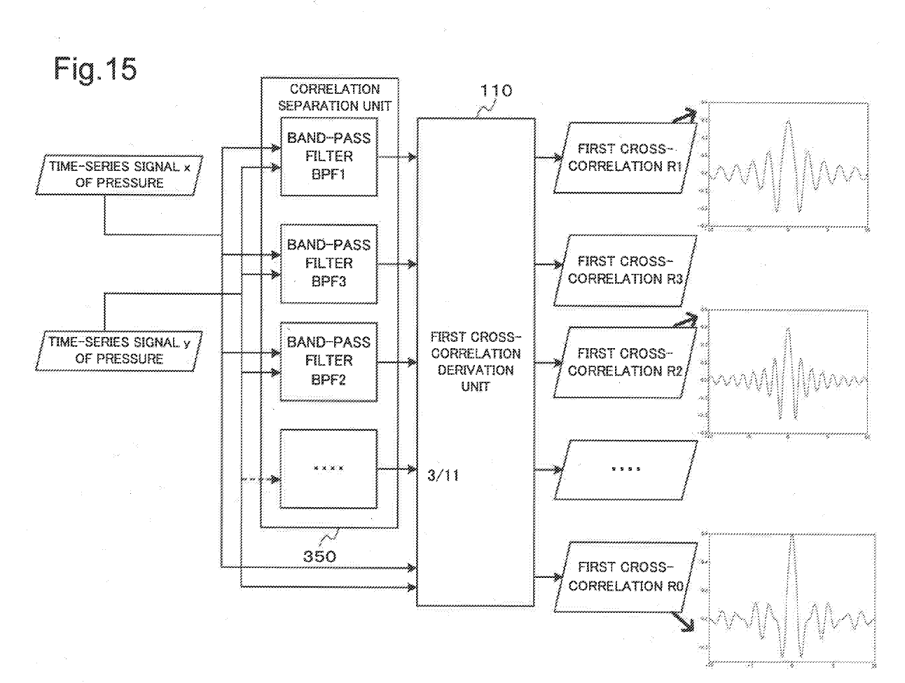

Next, the third example embodiment of the present invention will be described. FIG. 11 is a diagram illustrating a configuration of a position estimation device 300 in the third example embodiment of the present invention. FIG. 12 illustrates an example of a case where there is a difference in the propagation velocity of a pressure wave in a pipeline network. FIG. 13 illustrates another example of a case where there is a difference in the propagation velocity of a pressure wave in a pipeline network. FIG. 14 illustrates an example of a cross-correlation relating to a combined wave of pressure waves whose propagation velocities are different. FIG. 15 is a schematic diagram illustrating an example of an operation of a first cross-correlation derivation unit 110 and a correlation separation unit 350 in the third example embodiment of the present invention.

As illustrated in FIG. 11, the position estimation device 300 in the third example embodiment of the present invention includes the correlation separation unit 350, a first cross-correlation derivation unit 110, a second cross-correlation derivation unit 120, and an estimation unit 130. The correlation separation unit 350 separates a predetermined component from a measurement value for use in deriving at least one of first and second cross-correlations. Regarding configurations other than the above, the position estimation device 300 in the third example embodiment of the present invention includes the same configuration as the position estimation device 100 in the first example embodiment of the present invention.

Note that a position estimation system including the position estimation device 300 in the example embodiment is configured in the same manner as the position estimation system 10 or others in the first example embodiment of the present invention.

In the example embodiment, as described above, the correlation separation unit 350 separates a predetermined component from each of measurement values used for deriving at least one of first and second cross-correlations. In one example, the correlation separation unit 350 separates a predetermined frequency component from each of the aforementioned measurement values. In this case, the correlation separation unit 350 may separate and extract only a specific frequency component from each of the measurement values, or may separate the measurement values for each frequency component. Further, the correlation separation unit 350 may eliminate a noise component in estimating an occurrence position of a pressure wave in a pipeline network by the estimation unit 130. The correlation separation unit 350 is implemented by any kind of band-pass filter which extracts a component having a desired propagation frequency. The first cross-correlation derivation unit 110 and the second cross-correlation derivation unit 120 respectively derive first and cross-correlations for each component separated by the correlation separation unit 350, for instance. Note that the first cross-correlation derivation unit 110 and the second cross-correlation derivation unit 120 may derive the first and the second cross-correlations based on the measurement values respectively obtained by measuring a pressure of fluid flowing through a pipeline network at least at two positions in the pipeline network in the same manner as the aforementioned example embodiments.

A propagation velocity of a pressure wave may differ depending on a medium through which the pressure wave propagates, or a type of a pressure wave. When a pressure wave is generated in a pipeline network by a fault or rupture of a pipe, the pressure wave may be a combined wave of pressure waves whose propagation velocities are different.

FIG. 12 illustrates an example of a case where there is a difference in the propagation velocity of a pressure wave in a pipeline network. In the example illustrated in FIG. 12, when a pressure wave propagates through two types of media, i.e., an inner wall of a pipe and fluid flowing through the pipe, the pressure wave generated in a pipeline network is a combined wave of pressure waves whose propagation velocities are different. In the example illustrated in FIG. 12, when it is assumed that V1 is a propagation velocity of a pressure wave which propagates through an inner wall of a pipe, and V2 is a propagation velocity of a pressure wave propagating through fluid flowing through the pipe, a relation between the two velocities is V2<V1.

Further, FIG. 13 illustrates another example of a case where there is a difference in the propagation velocity of a pressure wave generated in a pipeline network. In the example illustrated in FIG. 13, a pressure wave in a pipeline network is a combined wave of pressure waves whose propagation velocities are different due to a difference in the wave type i.e. a compressional wave and a torsional wave. In the example illustrated in FIG. 12, when it is assumed that V1 is a propagation velocity of a compressional wave, and V2 is a propagation velocity of a torsional wave, a relation between the two velocities is V2<V1.

When a pressure wave in a pipeline network is a combined wave of pressure waves whose propagation velocities are different from each other, a first cross-correlation to be obtained by measuring the pressure waves may be such that local peaks illustrated in FIG. 5 are strengthened or weakened each other depending on the propagation velocities of the pressure waves.

FIG. 14 illustrates an example of a cross-correlation relating to a combined wave of pressure waves whose propagation velocities are different. FIG. 14(A) and FIG. 14(B) respectively represent examples of cross-correlations obtained from a pressure waves propagating at the propagation velocities V1 and V2 which are different from each other. On the other hand, FIG. 14(C) represents an example of a cross-correlation obtained from a combined wave of two pressure waves whose propagation velocities are V1 and V2. In the example illustrated in FIG. 14(C), as compared with the examples of FIGS. 14(A) and (B), a period at which local peaks of a cross-correlation appear is fluctuated. Using a combined wave as described above may affect estimation on an occurrence position of a pressure wave by the estimation unit 130 depending on a specific method for deriving a second cross-correlation.

In view of the above, in the example embodiment, the correlation separation unit 350 separates a predetermined component in such a manner that pressure waves of different propagation velocities are separated. Specifically, the correlation separation unit 350 separates a first cross-correlation to be obtained from a combined wave of pressure waves whose propagation velocities are different from each other into a component whose propagation velocity is the same (or whose propagation velocity lies in a predetermined range in which it is possible to handle that propagation velocities are the same). This makes it possible to reduce an influence on a pressure wave due to inclusion of a pressure wave having a different propagation velocity in a pressure wave from which a first cross-correlation is derived. Therefore, the position estimation device 300 in the example embodiment can estimate an occurrence position of a pressure wave by the estimation unit 130 with high accuracy.

As described above, the correlation separation unit 350 is implemented by any kind of band-pass filter which extracts a component having a desired propagation frequency as an example. Generally, when propagation velocities of pressure waves are different from each other, frequencies of pressure waves themselves or f cross-correlations thereof are different. Therefore, the correlation separation unit 350 can extract a component relating to a desired propagation velocity from a first cross-correlation by extracting a required frequency component with use of a band-pass filter as necessary.

FIG. 15 is a schematic diagram illustrating an example of an operation of the first cross-correlation derivation unit 110 and the correlation separation unit 350. In the example illustrated in FIG. 15, the correlation separation unit 350 internally includes at least band-pass filters BPF1 to BPF3. The band-pass filters BPF1 to PBF3 respectively pass frequency components different from each other. Further, the correlation separation unit 350 may include a band-pass filter which passes a frequency component different from the frequency components which the band-pass filters BPF1 to BPF3 pass.

In this example, the correlation separation unit 350 separates into frequency components respectively associated with propagation velocities different from each other based on time-series signals x and y of a pressure, which are measured in a pipeline network. The first cross-correlation derivation unit 110 derives first cross-correlations R1 to R3 corresponding to frequency components respectively associated with propagation velocities different from each other. Further, the first cross-correlation derivation unit 110 derives a first cross-correlation R0 based on the time-series signals x and y of a pressure, which are measured in a pipeline network.

Further, in the example embodiment, the second cross-correlation derivation unit 120 may derive a second cross-correlation, which is separated into frequency components respectively corresponding to first cross-correlations R1 to R3, in response to an operation of the correlation separation unit 350. In this case, the estimation unit 130 estimates an occurrence position of a pressure wave based on the first cross-correlation and the second cross-correlation, which are separated for each frequency component as described above.

Note that in the example embodiment, the second cross-correlation derivation unit 120 may derive a second cross-correlation without separating a pressure wave for each propagation velocity or for each frequency component. In this case, the correlation separation unit 350 may separate a predetermined component relating to not only a first cross-correlation but also a second cross-correlation, as necessary.

As described above, the position estimation device 300 in the third example embodiment of the present invention includes the correlation separation unit 350. The correlation separation unit 350 separates a predetermined component from a measurement value for use in deriving at least one of first and second cross-correlations. Thus, when an occurrence position of a pressure wave is estimated by the estimation unit 130, an influence due to a difference in the propagation velocity is reduced, even in a case where a pressure wave is a combined wave of pressure waves whose propagation velocities are different. Therefore, the position estimation device 300 in the example embodiment can estimate an occurrence position of a pressure wave with enhanced accuracy.

Note that the configuration of the position estimation device 300 in the example embodiment can be combined with the modification of the position estimation device 100 in the first example embodiment, or the position estimation device 200 in the second example embodiment as necessary.

In the foregoing, the invention of the present application is described referring to the example embodiments. The invention of the present application, however, is not limited to the aforementioned example embodiments. It will be understood by those of ordinary skill in the art that various changes in form and details may be made therein without departing from the spirit and scope of the present invention. Further, the configurations of each of the example embodiments can be combined with each other, as far as the combination does not depart from the scope of the present invention.

This application claims the priority based on Japanese Patent Application No. 2014-238050 filed on Nov. 25, 2014, the entire disclosure of which is hereby incorporated.

### REFERENCE SIGNS LIST

10, 20, 30 Position estimation system
100, 200, 300 Position estimation device
110 First cross-correlation derivation unit
120 Second cross-correlation derivation unit
130 Estimation unit
240 Predicted position setting unit
350 Correlation separation unit
50, 51, 52 Pipeline network
500, 501 Pipe
531, 532, 533, 534 Tank
541, 542, 543, 544 Pump
551, 552, 553 Pressure meter
561, 562, 563 Pressure detection unit
571, 572, 573, 574, 575,576, 577, 578 Intersection point
1000 Information processing device
1001 CPU
1002 ROM
1003 RAM
1004 Program
1005 Storage device
1006 Recording medium
1007 Drive device
1008 Communication interface
1009 Communication network
1010 Input-output interface
1011 Bus

1. A position estimation device comprising:
a memory storing a program instructions to realize a plurality of units; and
a processor configured to execute the program instructions, the program instructions including:
a first cross-correlation derivation unit configured to derive a first cross-correlation relating to a measurement value based on the measurement values indicating a pressure of fluid flowing through a pipeline network and respectively measured at least at two positions in the pipeline network;
a second cross-correlation derivation unit configured to derive a second cross-correlation relating to a calculation value based on the calculation value obtained by respectively calculating the pressure of the fluid at least at the two positions in the pipeline network; and
an estimation unit configured to estimate an occurrence position of a pressure wave in the pipeline network based on the first cross-correlation and the second cross-correlation.

2. The position estimation device according to claim 1, wherein
the estimation unit estimates the occurrence position of the pressure wave based on a difference between the first cross-correlation and the second cross-correlation.

3. The position estimation device according to claim 1, wherein
the second cross-correlation derivation unit sets a predicted occurrence position of a pressure wave in the pipeline network, and derives the second cross-correlation for a case where a pressure wave is generated at the predicted occurrence position of the pressure wave.

4. The position estimation device according to claim 3, wherein
the estimation unit estimates the predicted occurrence position of the pressure wave used in deriving the second cross-correlation by the second cross-correlation derivation means as the occurrence position of the pressure wave in the pipeline network when a difference between the first cross-correlation and the second cross-correlation satisfies a predetermined condition.

5. The position estimation device according to claim 3, the program instruction further including:
predicted position setting means for repeatedly setting the predicted occurrence position of the pressure wave at which a pressure of fluid is calculated by the second cross-correlation derivation means.

6. The position estimation device according to claim 5, wherein
the predicted position setting unit selects at least one position from a plurality of predetermined positions in the pipeline network, and sets the position selected as the predicted occurrence position of the pressure wave.

7. The position estimation device according to claim 6, wherein
the predicted position setting unit selects at least one position from the plurality of the predetermined positions in the pipeline network based on the occurrence position of the pressure wave satisfying the predetermined condition, and sets the selected position as the predicted occurrence position of the pressure wave when a difference between the first cross-correlation and the second cross-correlation satisfies the predetermined condition at the occurrence position of the pressure wave that is being set.

8. The position estimation device according to claim 6, wherein
the predicted position setting unit sets a predicted occurrence position of a pressure wave to a position different from the plurality of predetermined positions in the pipeline network when a difference between the first cross-correlation and the second cross-correlation satisfies the predetermined condition at least at one of the plurality of predetermined positions.

9. The position estimation device according to claim 1, the program instruction further including:
a correlation separation unit configured to separate a predetermined component from at least one of the first cross-correlation and the second cross-correlation.

10. The position estimation device according to claim 9, wherein
the correlation separation unit separates a predetermined frequency component from each of the first cross-correlation and the second cross-correlation, and
the estimation unit estimates the occurrence position of the pressure wave based on the predetermined frequency components of the first cross-correlation and the second cross-correlation.

11. The position estimation device according to claim 10, wherein
the correlation separation unit separates the first cross-correlation and the second cross-correlation into the plurality of predetermined frequency components, and
the estimation unit estimates the occurrence position of the pressure wave based on respective differences of the plurality of predetermined frequency components between the first cross-correlation and the second cross-correlation.

12. A position estimation system comprising:
the position estimation device according to claim 1; and
a plurality of pressure detection unit configured to measure a pressure of fluid flowing through the pipeline network.

13. A position estimation method comprising:
deriving a first cross-correlation relating to a measurement value based on the measurement value respectively obtained by measuring a pressure of fluid flowing through a pipeline network at least at two positions in the pipeline network;
deriving a second cross-correlation relating to a calculation value based on the calculation value obtained by respectively calculating the pressure of the fluid at least at the two positions in the pipeline network; and
estimating an occurrence position of a pressure wave based on the first cross-correlation and the second cross-correlation.

14. A non-transitory computer-readable recording medium storing a program causing a computer to execute:
a process of deriving a first cross-correlation relating to a measurement value based on the measurement value indicating a pressure of fluid flowing through a pipeline network and respectively measured at least at two positions in the pipeline network;
a process of deriving a second cross-correlation relating to a calculation value based on the calculation value obtained by respectively calculating the pressure of the fluid at least at the two positions in the pipeline network; and
a process of estimating an occurrence position of a pressure wave based on the first cross-correlation and the second cross-correlation.
